(19) United States
(12) Patent Application Publication
(10) Pub. No.: US 2003/0174368 A1
(43) Pub. Date: Sep. 18, 2003

(54) Image-recording device and method for monitoring recording material winding state of the device

(76) Inventor: Toru Katayama, Kanagawa (JP)

Correspondence Address: Sheldon J. Moss, c/o Yumi Yerks, Apartment #412-North, 2111 Jefferson Davis Highway, Arlington, VA, 22202, US

(21) Appl. No.: 10/382,582

(22) Filed: Mar. 7, 2003

(30) Foreign Application Priority Data
Mar. 12, 2002 (JP) 2002-66653

(51) Int. Cl. H04N 1/04

(52) U.S. Cl. 358/490; 358/474

(57) ABSTRACT

Misidentification, when a sheet-form recording material of a size different from an identified size is conveyed and wound on a rotating drum, is detected before proceeding to exposure processing, which is a subsequent process. When a trailing end of a printing plate is detected by a photo-interrupter, an actual plate length is calculated on the basis of an already known conveyance length and either a rotation angle of the rotating drum due to the operation of winding up till this detection or a product of a rotation linear speed of the rotating drum and a duration of the operation. If a difference between the actual plate length and an inputted plate length falls beyond pre-specified tolerance values, the printing plate is wound backward and separated from the rotating drum.

### BACKGROUND OF THE INVENTION

1. Field of the Invention

The present invention relates to an image-recording device which, in a state in which a sheet-form recording material is wound on a peripheral surface of a rotating drum, records an image by rotating the recording material at a predetermined rotation speed and moving a recording head, which is disposed facing the peripheral surface of the rotating drum, in an axial direction of the rotating drum, and relates to a recording material winding state monitoring method which monitors whether or not a dimension of the sheet-form recording material accords with an inputted size.

2. Description of the Related Art

Development of technologies (printing plate exposure devices) which employ a sheet-form recording material, particularly a printing plate in which a photosensitive layer is provided on a support, and record an image on the photosensitive layer (an emulsion layer) of the printing plate with a direct laser beam or the like, by moving a recording head in an axial direction of a rotating drum (sub-scanning) while the rotating drum is rotated at high speed (main scanning) in a state in which the printing plate has been wound on a peripheral surface of the rotating drum, has been progressing. With such technologies, rapid recording of images onto printing plates is possible.

At the time of image recording, rotation of the rotating drum is controlled by use of a servo motor. While the rotating drum rotates and feedback is obtained in accordance with signals from a rotary encoder, image data is transmitted to the recording head. Thus, the image recording can be performed with high accuracy.

Further, because the image recording is carried out at high accuracy, the printing plate must be wound onto the peripheral surface of the rotating drum tightly and without gaps. Accordingly, a leading end of a printing plate conveyed from a tangential direction of the rotating drum is fixedly retained at a leading end chuck. In this state, the rotating drum is rotated and the printing plate is gradually wound on. Finally, a trailing end of the printing plate is fixedly retained by a trailing end chuck.

Here, it is necessary that notification be given in advance if a position of the trailing end chuck differs from a position according to a size of the printing plate (a conveyance direction dimension). This size of the printing plate can be variously designated by automatic input from an upstream image-processing device, manual input by an operator, or the like. Particularly in the case of manual input by an operator, it is conceivable that the size of an actually loaded printing plate could differ from the inputted size.

If a printing plate whose size differs from the inputted size is loaded, there is no problem with preparation for fixing at the leading end chuck, but the position of the trailing end chuck will be misidentified. Thus, the trailing end chuck may not be fixedly retained at an appropriate position of the printing plate. Rotation speeds of rotating drums have become faster as processing speeds have increased and resolutions have become higher. Therefore, with rotation in a state in which the trailing end of the printing plate is not assuredly fixedly retained, as well as proper image recording not being possible, problems occur with breakages due to contact of the printing plate against peripheral devices, detachment of the printing plate, damage to the printing plate, and the like.

### SUMMARY OF THE INVENTION

In consideration of the circumstances described above, an object of the present invention is to provide an image-recording device which can detect misidentification when a sheet-form recording material whose size differs from an identified size is conveyed to and wound on a rotating drum, before the recording material is moved in a subsequent step of exposure processing, and to provide a method for monitoring a recording material winding state of this device.

A first aspect of the present invention is an image-recording device which, in a state in which a sheet-form recording material is wound on a peripheral surface of a rotating drum, rotates the rotating drum at a predetermined rotation speed and moves a recording head, which is disposed to face the peripheral surface of the rotating drum, in an axial direction of the rotating drum for recording an image, the image-recording device comprising: a rotation position detection sensor which detects a rotation angle of the rotating drum; a determined position angle storage section which stores a rotation angle of a time when a leading end chuck, which is provided at the rotating drum and fixedly retains a leading end portion of the sheet-form recording material, is positioned at a determined position for receiving the sheet-form recording material; a trailing end detection sensor which is provided on a conveyance path of the sheet-form recording material to the rotating drum and detects a trailing end portion of the sheet-form recording material, a path length between the trailing end detection sensor and the leading end chuck when the rotating drum is positioned at the determined position being known in advance; a trailing end detection angle acquisition section which acquires a rotation angle of the rotating drum from the rotation position detection sensor when the trailing end of the sheet-form recording material is detected by the trailing end detection sensor during an operation of winding the sheet-form recording material onto the rotating drum; and a length dimension calculation section which calculates a length dimension of the sheet-form recording material on the basis of the rotation angle acquired by the trailing end detection angle acquisition section, a diametric dimension of the rotating drum and the path length.

According to the first aspect of the present invention, when a sheet-form recording material is to be wound on the rotating drum, first, a leading end chuck fixedly provided at the rotating drum is set to a position for receiving the sheet-form recording material, which is the determined position. From this state, the sheet-form recording material proceeds to be wound onto the peripheral surface of the rotating drum. A rotation angle at this time is stored at the determined position angle storage section.

While the sheet-form recording material is being gradually wound on by rotation of the rotating drum, a trailing end portion of the sheet-form recording material reaches the position of the trailing end detection sensor.

At the point in time when the trailing end portion is detected by the trailing end detection sensor, a rotation angle is acquired from the rotation position detection sensor. Consequently, a rotation angle of the leading end portion of the recording material that is fixedly retained at the leading end chuck can be found from a difference between the rotation angle that is acquired and the angle of the determined position that has been stored.

The length dimension calculation section calculates an actual length dimension L of the recording material from the rotation angle D (radians) found above, a diametric dimension of the rotating drum (for example, a radius R may be registered in advance), and the path length L₁ from the determined position to the trailing end detection sensor. An equation for this calculation is as follows:

D×R=L−L₁ (1)

L=D×R+L₁ (1)

If the unit of D is to be converted from radians to degrees, D′ (deg)=D (rad)×360/2. Thus, equation (2) becomes:

L=(D′/360)×2 R+L₁ (3)

In a case in which a size based on the result of this calculation differs from a size of the sheet-form recording material that has been inputted, for example, manually, the apparatus is halted or the like before the rotating drum rotates at high speed for exposure processing, and problems can be pre-emptively avoided.

A second aspect of the present invention is an image-recording device which, in a state in which a sheet-form recording material is wound on a peripheral surface of a rotating drum, rotates the rotating drum at a predetermined rotation speed and moves a recording head, which is disposed to face the peripheral surface of the rotating drum, in an axial direction of the rotating drum for recording an image, the image-recording device comprising: a leading end chuck provided at the rotating drum which fixedly retains a leading end portion of the sheet-form recording material; a trailing end detection sensor which is provided on a conveyance path of the sheet-form recording material to the rotating drum and detects a trailing end portion of the sheet-form recording material, a path length between the trailing end detection sensor and the leading end chuck when the leading end chuck is positioned at a determined position being known in advance; a timer which starts contemporaneously with commencement of an operation of winding the sheet-form recording material onto the rotating drum and stops when the trailing end of the sheet-form recording material is detected by the trailing end detection sensor; and a length dimension calculation section which calculates a length dimension of the sheet-form recording material on the basis of a duration measured by the timer, rotation linear velocity of the rotating drum and the path length.

According to the second aspect of the present invention, when a sheet-form recording material is to be wound on the rotating drum, first, a leading end chuck fixedly provided at the rotating drum is set to a position for receiving the sheet-form recording material, which is the determined position. From this state, the sheet-form recording material proceeds to be wound onto the peripheral surface of the rotating drum. The timer is started at a time of commencement of rotation of the rotating drum.

While the sheet-form recording material is being gradually wound on by rotation of the rotating drum, a trailing end portion of the sheet-form recording material reaches the position of the trailing end detection sensor.

At the point in time when the trailing end portion is detected by the trailing end detection sensor, the timer is stopped and a measured duration is read out.

The length dimension calculation section finds a length L₂ of a portion of the sheet-form recording material that is rearward of the trailing end detection sensor at the time when the recording material is fixedly retained at the leading end chuck, from a product of the measured duration t and linear velocity v of the rotating drum. Further, the length dimension calculation section calculates an actual length dimension L of the recording material from a sum of the length L₂ and the path length L₁ from the determined position to the trailing end detection sensor. Equations for these calculations are as follows:

L₂=v×t (4)

L=L₁+L₂ (5)

In a case in which a size based on the result of this calculation differs from a size of the sheet-form recording material that has been inputted, for example, manually, the apparatus is halted or the like before the rotating drum rotates at high speed for exposure processing, and problems can be preemptively avoided.

A third aspect of the present invention is the second aspect, further including a squeeze roller which, during a temporary stoppage of the rotating drum after rotation has commenced in a state in which the leading end of the sheet-form recording material is retained by the leading end chuck and the leading end chuck has passed the squeeze roller, moves in a direction approaching the rotating drum from a position that is separated from the rotating drum, the squeeze roller continuing so as to push the sheet-form recording material against the peripheral surface of the rotating drum during re-commenced rotation operation of the rotating drum, wherein the timer measures durations of rotation of the rotating drum before and after the temporary stoppage respectively separately.

According to the third aspect of the present invention, the rotating drum starts to rotate after the leading end of the sheet-form recording material has been retained by the leading end chuck. During this rotation, the rotating drum is temporarily stopped while the squeeze roller is moved (is brought in a direction approaching the rotating drum). A rotation linear velocity v₁ of the rotating drum before the temporary stoppage may be different from a rotation linear velocity v₂ after the squeeze roller has been pushed against the rotating drum (v₁<v₂).

Accordingly, rotation durations of the rotating drum before and after the temporary stoppage are measured respectively separately at the timer. (A time t₁ corresponding to v₁, a time t₂ corresponding to v₂, and hence the length L₂ of the sheet-form recording material that is rearward of the trailing end detection sensor when the recording material is fixedly retained at the leading end chuck are found from products of vᵢ and tᵢ; i=1, 2.)

Specifically, shown as an equation for calculation, the length L₂ of the sheet-form recording material that is rearward of the trailing end detection sensor when the recording material is fixedly retained at the leading end chuck is represented by the following equation (6):

L₂=(v₁×t₁)+(v₂×t₂) (6)

Accordingly, even if there is a difference in rotation speeds of the rotation drum before and after the squeeze roller movement process, the correct length L can be calculated.

A fourth aspect of the present invention is any of the first to third aspects, further including: an input section for inputting a length dimension of the sheet-form recording material; a comparison section which compares the dimension inputted at the input section with the dimension calculated at the length dimension calculation section; and a notification section which gives notice of a result of the comparison by the comparison section.

According to the fourth aspect of the present invention, the length dimension of the sheet-form recording material that is inputted from the input section and the length dimension calculated as a result of calculation by the length dimension calculation section are compared by the comparison section. Notification of the result of this comparison is given, and a judgement of error can be performed quickly.

A fifth aspect of the present invention is any of the first to third aspects, further including: an input section for inputting a length dimension of the sheet-form recording material; a comparison section which compares the dimension inputted at the input section with the dimension calculated at the length dimension calculation section; and a processing interruption section which interrupts winding processing of the sheet-form recording material in a case in which a result of the comparison at the comparison section does not coincide with a pre-specified allowable range.

According to the fifth aspect of the present invention, the length dimension of the sheet-form recording material that is inputted from the input section and the length dimension calculated as a result of calculation by the length dimension calculation section are compared by the comparison section. If the result of this comparison does not fall within a range of tolerance specified in advance, the process of winding on the sheet-form recording material is suspended, and thus breakage of the drum and peripheral devices thereof, damage to the recording material itself and the like due to misidentification of the size can be assuredly prevented.

A sixth aspect of the present invention is recording material winding state monitoring method which is employed at an image-recording device which, in a state in which a sheet-form recording material is wound on a peripheral surface of a rotating drum, rotates the rotating drum at a predetermined rotation speed and moves a recording head, which is disposed to face the peripheral surface of the rotating drum, in an axial direction of the rotating drum for recording an image, the method being for monitoring whether or not a dimension of the sheet-form recording material that is wound on accords with an inputted size, the method comprising the steps of: preparatorily storing a conveyance length, from a position at which a leading end of the sheet-form recording material is fixedly retained at the rotating drum to a predetermined position on a conveyance path for feeding the sheet-form recording material to the rotating drum; detecting a rotation angle of the rotating drum in rotating from commencement of winding of the sheet-form recording material onto the rotating drum, at a point in time at which the leading end of the sheet-form recording material has been fixedly retained at the rotating drum, until a trailing end of the sheet-form recording material reaches the predetermined position; calculating an actual dimension of the sheet-form recording material from the rotation angle, a diametric dimension of the rotating drum and the conveyance length; comparing the inputted size dimension with the calculated dimension; and giving notice of a result of the comparison.

According to the sixth aspect of the present invention, when a sheet-form recording material is to be wound on the rotating drum, first, a leading end chuck fixedly provided at the rotating drum is set to a position for receiving the sheet-form recording material, which is the determined position. From this state, the sheet-form recording material proceeds to be wound onto the peripheral surface of the rotating drum. A rotation angle at this time is stored.

The sheet-form recording material proceeds to be gradually wound on by rotation of the rotating drum, and when a trailing end portion of the sheet-form recording material reaches a predetermined position, a rotation angle of the rotating drum is detected. An actual length dimension of the recording material is calculated on the basis of this rotation angle, a diametric dimension of the rotating drum (for example, a radius R may be registered in advance), and the conveyance length.

Next, the inputted length dimension of the sheet-form recording material and the calculated length dimension are compared. Notification of the result of this comparison is given, and if the size differs from a size of the sheet-form recording material that has been inputted, for example, manually, then the apparatus is halted or the like before the rotating drum rotates at high speed for exposure processing, and problems can be pre-emptively avoided.

A seventh aspect of the present invention is a recording material winding state monitoring method which is employed at an image-recording device which, in a state in which a sheet-form recording material is wound on a peripheral surface of a rotating drum, rotates the rotating drum at a predetermined rotation speed and moves a recording head, which is disposed to face the peripheral surface of the rotating drum, in an axial direction of the rotating drum for recording an image, the method being for monitoring whether or not a dimension of the sheet-form recording material that is wound on accords with an inputted size, the method comprising the steps of: preparatorily storing a conveyance length, from a position at which a leading end of the sheet-form recording material is fixedly retained at the rotating drum to a predetermined position on a conveyance path for feeding the sheet-form recording material to the rotating drum; measuring a duration of winding the sheet-form recording material onto the rotating drum, including the sub-steps of commencing a time measurement from a point in time at which the leading end of the sheet-form recording material has been fixedly retained at the rotating drum and the rotating drum has commenced rotation, and finishing the time measurement at a point in time at which a trailing end of the sheet-form recording material has reached the predetermined position; calculating an actual dimension of the sheet-form recording material from the measured duration, a linear speed of rotation of the rotating drum and the conveyance length; comparing the inputted size dimension with the calculated dimension; and giving notice of a result of the comparison.

According to the seventh aspect of the present invention, when a sheet-form recording material is to be wound on the rotating drum, first, a leading end chuck fixedly provided at the rotating drum is set to a position for receiving the sheet-form recording material, which is the determined position. From this state, the sheet-form recording material proceeds to be wound onto the peripheral surface of the rotating drum. Commencement of rotation of the rotating drum at this time acts as a trigger for commencement of time measurement.

The sheet-form recording material proceeds to be gradually wound on by rotation of the rotating drum, and when a trailing end portion of the sheet-form recording material has reached a predetermined position, the time measurement ends. An actual length dimension of the recording material is calculated on the basis of this measured time duration, a linear velocity of rotation of the rotating drum, and the conveyance length.

Next, the inputted length dimension of the sheet-form recording material and the calculated length dimension are compared. Notice of the result of this comparison is given, and if the size differs from a size of the sheet-form recording material that has been inputted, for example, manually, then the apparatus is halted or the like before the rotating drum rotates at high speed for exposure processing, and problems can be preemptively avoided.

An eighth aspect of the present invention is either of the sixth and seventh aspects which further comprising, in a case in which the result of the comparison does not coincide with an allowable range, the steps of feeding the sheet-form recording material backward and removing the sheet-form recording material from the rotating drum.

According to the eighth aspect of the present invention, if the result of the comparison does not fall within a range of tolerance specified in advance, the process of winding on the sheet-form recording material is suspended, and thus breakage of the drum and peripheral devices thereof, damage to the recording material itself and the like due to misidentification of the size can be assuredly prevented.

### BRIEF DESCRIPTION OF THE DRAWINGS

FIG. 1 is a systematic view of a printing plate automatic exposure device relating to a first embodiment.

FIG. 2 is a block diagram showing schematics of a controller for driving a rotating drum and recording head relating to the first embodiment.

FIGS. 3A to 3C are operational views showing states of feeding of a printing plate to the rotating drum, relating to the first embodiment.

FIGS. 4A and 4B are a flowchart showing a control routine forjudging a size (plate length) of a printing plate, relating to the first embodiment.

FIG. 5 is a block diagram showing schematics of a controller for driving a rotating drum and recording head relating to a second embodiment.

FIGS. 6A to 6C are operational views showing states of feeding of a printing plate to the rotating drum, relating to the second embodiment.

FIGS. 7A and 7B are operational views showing states of printing plate feeding based on a plate length judgement result, relating to the second embodiment.

FIGS. 8A and 8B are a flowchart showing a control routine for judging a size (plate length) of a printing plate, relating to the second embodiment.

### DESCRIPTION OF THE PREFERRED EMBODIMENTS

First Embodiment

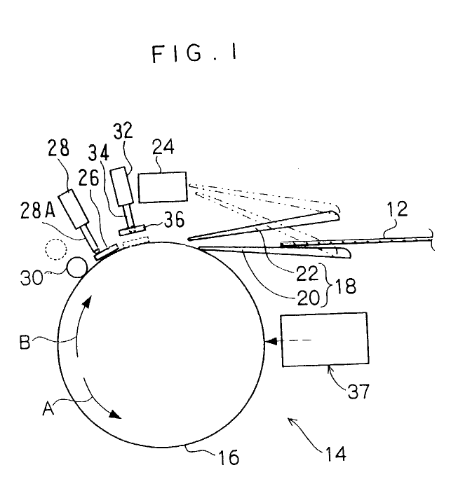

FIG. 1 shows an exposure section 14 of a printing plate automatic exposure device relating to a first embodiment.

A rotating drum 16, at a peripheral surface of which a printing plate 12 is wound on and retained, serves as a principal portion structuring the exposure section 14. The printing plate 12 is guided by a conveyance guide unit 18, and is fed in to the rotating drum 16 from a tangential direction of the rotating drum 16.

Upward of the rotating drum 16 in FIG. 1, a puncher 24 is provided.

The conveyance guide unit 18 is structured with a plate supply guide 20 and a plate ejection guide 22.

A positional relationship of the plate supply guide 20 and the plate ejection guide 22 of the conveyance guide unit 18 relative to one another is set to a horizontal V shape, and the plate supply guide 20 and plate ejection guide 22 form a structure which rotates through a predetermined angle about a center of rotation which is at the left end side of FIG. 1. Consequent to this rotation, the plate supply guide 20 and plate ejection guide 22 can be selectively made to correspond with the rotating drum 16 or the puncher 24.

First, the printing plate 12 is guided by the plate supply guide 20 and fed in to the puncher 24, and a cut-out for positioning is formed at a leading end of the printing plate 12.

After processing by the puncher 24, the printing plate 12 is temporarily returned to the plate supply guide 20, and then moved to a position corresponding with the rotating drum 16.

The rotating drum 16 is rotated in a direction for loading and exposing the printing plate 12 (the direction of arrow A in FIG. 1) and in a direction of removing the printing plate 12 (the direction of arrow B in FIG. 1), which is a direction opposite to the loading/exposing direction, by an unillustrated drive section.

As shown in FIG. 1, a leading end chuck 26 is attached to the rotating drum 16 provided at the exposure section 14, at a predetermined position of the outer peripheral surface. When the printing plate 12 is to be loaded at the rotating drum 16, first, the rotating drum 16 is stopped with the leading end chuck 26 at a position facing a leading end of the printing plate 12 which is being fed in by the plate supply guide 20 of the conveyance guide unit 18 (a printing plate loading position).

A mounting unit 28 is provided facing the leading end chuck 26 at the printing plate loading position. When one end side of the leading end chuck 26 is pushed by extension of an extending/contracting rod 28A of the mounting unit 28, insertion of the printing plate 12 between the leading end chuck 26 and the peripheral surface of the rotating drum 16 becomes possible.

In a state in which the leading end of the printing plate 12 has been inserted between the leading end chuck 26 and the rotating drum 16, the extending/contracting rod 28A of the mounting unit 28 is withdrawn and pressure on the leading end chuck 26 is released. Consequently, the printing plate 12 is sandwiched between the leading end chuck 26 and the peripheral surface of the rotating drum 16, and retained.

At this time, the leading end of the printing plate 12 is abutted against positioning pins (not shown), which are provided at the rotating drum 16. Thus, the printing plate 12 is positioned.

When the leading end of the printing plate 12 has been fixed at the rotating drum 16, the rotating drum 16 rotates in the loading/exposing direction. Consequently, the printing plate 12 being fed in from the plate supply guide 20 of the conveyance guide unit 18 is wound on the peripheral surface of the rotating drum 16.

A squeeze roller 30 is disposed in a vicinity of the peripheral surface of the rotating drum 16, at a downstream side in the loading/exposing direction from the printing plate loading position. By moving toward the rotating drum 16, the squeeze roller 30 pushes the printing plate 12 being wound on the rotating drum 16 toward the rotating drum 16, and contacts the printing plate 12 tightly against the peripheral surface of the rotating drum 16.

In the exposure section 14, a trailing end chuck attaching/removing unit 32 is disposed in a vicinity upstream from the squeeze roller 30 with respect to the loading/exposing direction of the rotating drum 16. At the trailing end chuck attaching/removing unit 32, a trailing end chuck 36 is mounted at a distal end of a shaft 34, which protrudes towards the rotating drum 16.

When a trailing end of the printing plate 12 being wound onto the rotating drum 16 opposes the trailing end chuck attaching/removing unit 32, the shaft 34 is projected and the trailing end chuck 36 is mounted at a predetermined position of the rotating drum 16. Consequently, the trailing end chuck 36 sandwiches and retains the trailing end of the printing plate 12 between the trailing end chuck 36 and the rotating drum 16.

When the leading end and trailing end of the printing plate 12 are retained at the rotating drum 16, the squeeze roller 30 is moved away. Thereafter, the rotating drum 16 is rapidly rotated at a predetermined rotation speed (main scanning) and, contemporaneously with this rotation of the rotating drum 16, a light beam modulated on the basis of image data is irradiated from a recording head section 37.

When scanning and exposure of the printing plate 12 has finished, the rotating drum 16 is temporarily stopped at a position at which the trailing end chuck 36 retaining the trailing end of the printing plate 12 faces the trailing end chuck attaching/removing unit 32, and the trailing end chuck 36 is removed from the rotating drum 16. Consequently, the trailing end of the printing plate 12 is released.

Then the rotating drum 16 is rotated in the direction for removal of the printing plate 12. Thus, the printing plate 12 is discharged, from a trailing end side thereof, along a tangential direction of the rotating drum 16 to the plate ejection guide 22 of the conveyance guide unit 18. Thereafter, the printing plate 12 is ejected to a developing device for subsequent processing.

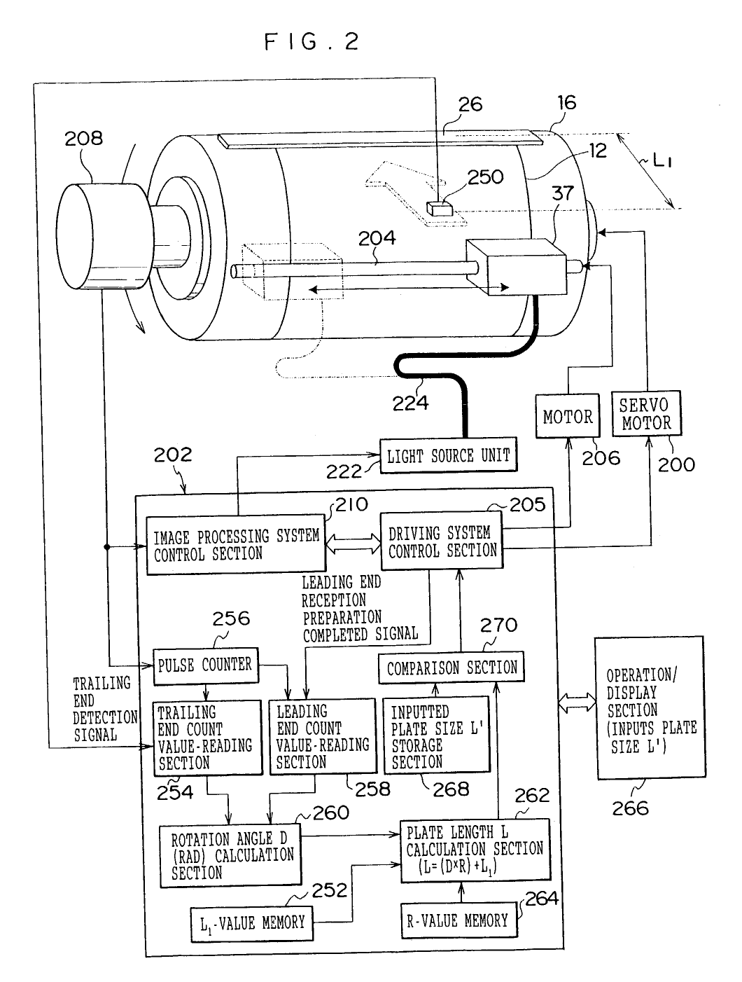

FIG. 2 shows a control system for rotation of the rotating drum 16, movement of the recording head section 37, and image recording by the recording head section 37 on the basis of image signals.

The rotating drum 16 is rotated by driving force of a servo motor 200. A rotation speed of the servo motor 200 is controlled on the basis of driving signals from a driving system control section 205 of a controller 202.

A shaft 204 of the recording head section 37 is axially rotated by a pulse motor 206, and thus the recording head section 37 is moved in an axial direction of the rotating drum 16. A driving speed of the motor 206 is controlled on the basis of driving signals from the driving system control section 205 of the controller 202.

A rotary encoder 208 is coaxially attached at a shaft portion at an axial direction one end portion of the rotating drum 16.

Pulse signals from the rotary encoder 208, which correspond with the rotation speed of the rotating drum 16, are transmitted to an image processing system control section 210 at the controller 202.

When an image clock is to be generated, the image processing system control section 210 generates an image clock which is incremented at a main scanning commencement time or the like for each occurrence of a predetermined rotation (for example, one full turn), on the basis of rotation of the rotating drum 16. The image processing system control section 210 also transmits image data corresponding to a number of lines that is required for main scanning at the same time to a light source unit 222.

A plurality of light sources (laser diodes or the like) are provided at the light source unit 222. The light from each light source is guided to the recording head section 37 through optical fiber 224.

The light source unit 222 outputs a light beam which is modulated on the basis of the inputted image signals. The light beam reaches the recording head section 37 via the optical fiber 224, and is irradiated towards the printing plate 12. Thus, by rotation of the rotating drum 16 (main scanning), and movement of the recording head section 37 (sub-scanning), an image is recorded on the printing plate 12.

In the first embodiment herein, judgement is carried out as to whether or not the size of the printing plate 12 that is being fed to the rotating drum 16 from the plate supply guide 20 matches a size identified in the apparatus (at the controller 202). For this judgement, a photo-interrupter 250 is provided in a vicinity of an end portion of the plate supply guide 20, at the rotating drum 16 side thereof, to serve as a trailing end detection sensor.

The photo-interrupter 250 is provided with a function for detecting a trailing end of the printing plate 12 that is being guided at the plate supply guide 20 and conveyed in the tangential direction of the rotating drum 16. A position of the photo-interrupter 250 has a fixed separation from the leading end chuck 26 when the rotating drum 16 is positioned in preparation for receiving the printing plate 12. A conveyance length L₁ of the printing plate 12 between the photo-interrupter 250 position and the leading end chuck 26 is stored in advance at an L₁-value memory 252 of the controller 202.

A trailing end detection signal of the photo-interrupter 250 is connected to a trailing end count value-reading section 254 provided at the controller 202, and serves as a trigger for reading out a count value. That is, a pulse counter 256, which counts up or down in response to signals from the rotary encoder 208, is provided at the controller 202. When the trailing end detection signal acting as the trigger is inputted to the trailing end count value-reading section 254, a current pulse count value (a trailing end count value L_{R}) is read from the pulse counter 256.

The pulse counter 256 is also connected to a leading end count value-reading section 258. At the leading end count value-reading section 258, a signal of completion of preparation for receiving the leading end, from the driving system control section 205, serves as a trigger, and a pulse count value from the pulse counter 256 at this time (a leading end count value L_{F}) is read out. Generally, the rotating drum 16 is always at the same position at the leading end receiving preparation completion time. Accordingly, the leading end count value L_{F} to be read out is always the same value. Accordingly, the leading end count value may be stored in advance as a fixed value.

The pulse count values read out by the leading end count value-reading section 258 and the trailing end count value-reading section 254 (the leading end count value L_{F} and the trailing end count value L_{R}) are respectively inputted to a rotation angle calculation section 260. At the rotation angle calculation section 260, a difference between the two pulse count values is calculated. An angular amount corresponding to a pulse unit is stored in advance. Thus, an angle of rotation of the rotating drum 16, from fixedly retaining the leading end of the printing plate 12 at the leading end chuck 26 to detection of the trailing end of the printing plate 12 at the photo-interrupter 250, (D radians) can be calculated.

The rotation angle calculation section 260 is connected to a plate length calculation section 262. The plate length calculation section 262 is further connected to the L₁-value memory 252 and an R-value memory 264, at which a radius R of the rotating drum 16 is stored in advance. The plate length calculation section 262 calculates a plate length L using the following equation (7).

L=D×R+L₁ (7)

Herein:

L is the plate length of the actual printing plate 12 (a length in the winding direction);

L₁ is the conveyance length from the receiving position of the leading end chuck 26 to the photo-interrupter 250;

D is the rotation angle (in radians) of winding by the rotating drum, excluding winding of L₁; and

R is the radius of the rotating drum.

The controller 202 is connected to an operation/display section 266, which serves as a user interface. A size L′ of the printing plate 12 that is to be processed can be inputted from the operation/display section 266. The size L′ inputted at the operation/display section 266 is stored at an inputted plate size storage section 268.

The inputted plate size storage section 268 and the plate length calculation section 262 are each connected to a comparison section 270. The plate length L of the actual plate size and the plate length L′ of the inputted plate size are inputted to the comparison section 270.

At the comparison section 270, the plate length L of the actual plate size and the plate length L′ of the inputted plate size are compared, and it is judged whether or not (an absolute value of) a difference therebetween ΔL is within a predetermined value L_{S} (see equation (8) following).

(|L−L′|=ΔL:L_{S}) (8)

Here, “: ” signifies comparison of values to the left and right thereof, and herein distinguishes whether ΔL<L_{S} or ΔL≧L_{S}.

The result of comparison by the comparison section 270 is outputted to the driving system control section 205 and the operation/display section 266.

In this first embodiment, when ΔL<L_{S}, it is judged that the inputted size of the printing plate 12 matches the actual size. In this case, usual processing can continue and no special processing particularly needs to be executed.

However, if ΔL≧L_{S}, an instruction that the printing plate 12 that is in the process of being wound onto the rotating drum 16 should be wound backward is sent to the driving system control section 205, and a message to the effect of “trailing end chuck position specified by inputted size is erroneous” is displayed at the motor 206.

Hence, the operation of winding the printing plate 12 onto the rotating drum 16 can be interrupted in cases in which the trailing end chuck 36 will not fixedly retain the trailing end of the printing plate 12 reliably and the like.

Below, operation of the first embodiment is described.

The printing plate 12 on the plate supply guide 20 is fed in to the rotating drum 16, and the leading end portion of the printing plate 12 is retained by the leading end chuck 26. In this state, the printing plate 12 is wound tightly on the rotating drum 16 by rotation of the rotating drum 16. Then the rear end of the printing plate 12 is retained by the trailing end chuck 36, and thus preparation for exposure finishes.

In this state, image data is read in, and exposure processing by the light beam from the recording head section 37 is commenced. This exposure processing is “scanning exposure”, in which the rotating drum 16 is rotated at high speed (main scanning) and the recording head section 37 moves in the axial direction of the rotating drum 16.

When the exposure processing has finished, the conveyance guide unit 18 is switched (the plate ejection guide 22 is made to correspond with the rotating drum 16), and then the printing plate 12 wound on the rotating drum 16 is ejected in the tangential direction. At this time, the printing plate 12 is fed to the plate ejection guide 22.

When the printing plate 12 has been fed to the plate ejection guide 22, the conveyance guide unit 18 is switched, the plate ejection guide 22 is made to correspond with an ejection port, and the printing plate 12 is ejected. A developing section is provided in the direction of this ejection, and the printing plate 12 continues on to be processed for development.

The sequence of operations of the printing plate 12, from conveyance, from the plate supply guide 20 to the rotating drum 16, and winding until exposure processing and ejection, is executed automatically. However, if the position of the trailing end chuck 36 based on the size of the printing plate 12 varies, input of the size of the printing plate 12 is required. In a case in which the size of the printing plate 12 is automatically read in from a device that transmits image data or the like, the size will very rarely be wrong, but in a case in which an operator inputs the size of the printing plate 12 manually, a potential rate of occurrence of input errors is comparatively high, due to the input being manual:

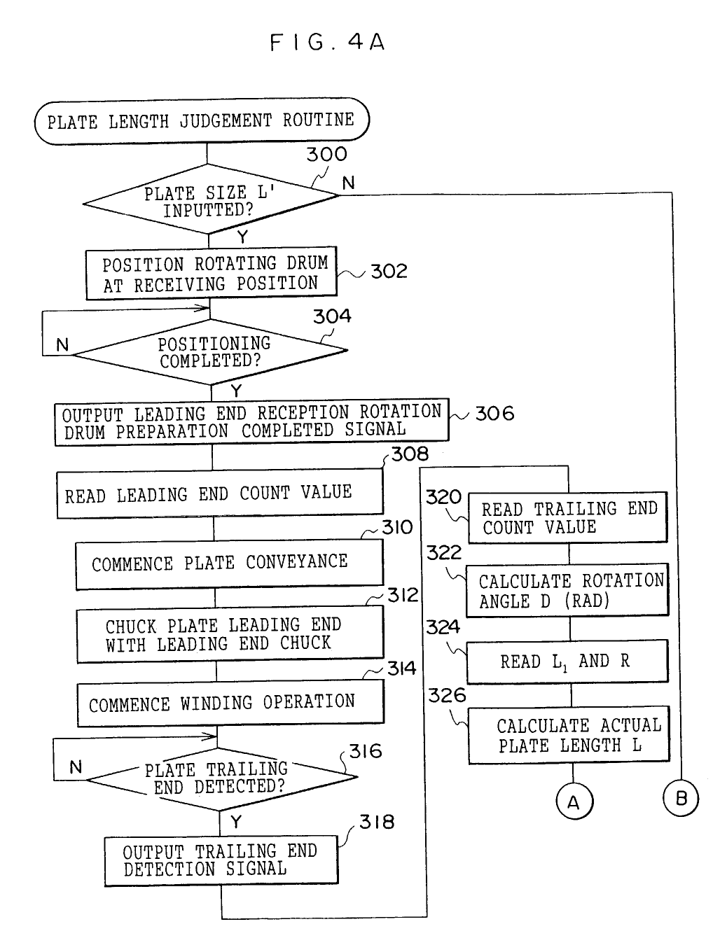

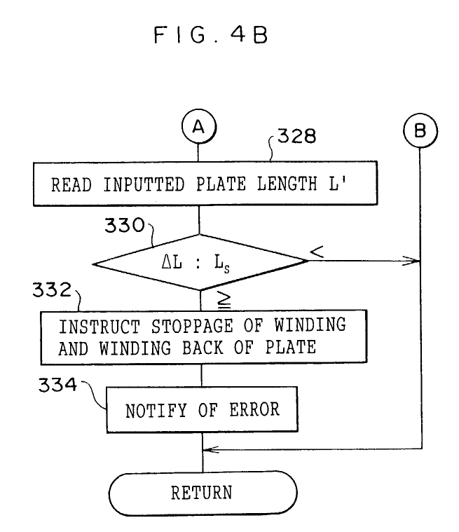

If the size (plate length) of the printing plate 12 identified by the apparatus is incorrect due to such an input error or the like, the position of the trailing end chuck 36 may not be a correct position, and the rotating drum 16 might be rotated at high speed with the printing plate 12 in a state in which fixed retention by the trailing end chuck 36 has not been fully achieved. As a result, as well as image recording not being carried out properly, there could be problems with the rotating drum 16 and peripheral devices thereof (the recording head section 37 and the like) being damaged due to the looseness of the printing plate 12, and the printing plate 12 itself could be damaged or detached. Accordingly, in the first embodiment, it is judged whether or not the plate size (plate length) identified by the apparatus (the controller 202) matches the plate size (plate length) of the printing plate 12 that has actually been wound on before the printing plate 12 has been completely wound on to the rotating drum 16, that is, before exposure processing begins. Below, a plate length judgement routine is described in accordance with a flowchart shown in FIGS. 4A and 4B.

In step 300, it is judged whether or not a plate size L′ has been inputted by the operation/display section 266. If this judgement is positive, the routine advances to step 302 and the rotating drum 16 is positioned at the position for receiving the printing plate 12.

In a next step 304, it is judged whether or not this positioning has been completed. When this judgement is positive, the routine advances to step 306, and a signal that preparation of the rotating drum 16 for receiving the leading end is complete is outputted from the driving system control section 205 to the leading end count value-reading section 258.

In a next step 308, with the leading end receiving preparation completion signal acting as a trigger, the leading end count value LF is read out from the pulse counter.

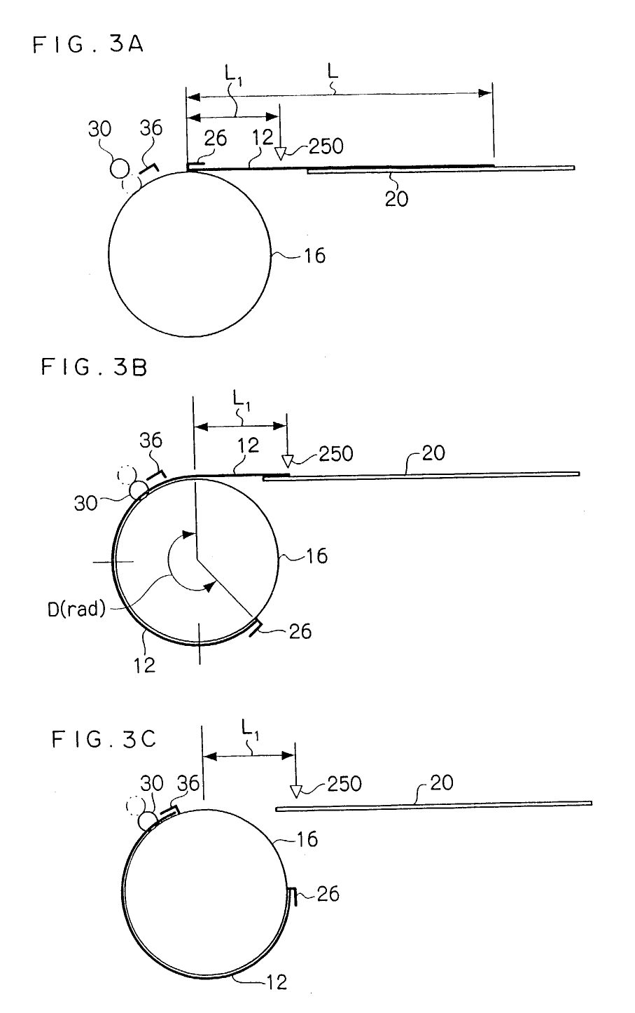

In a next step 310, conveyance of the printing plate 12 is commenced. When the leading end of the printing plate 12 arrives at the position at which the leading end chuck 26 is positioned (see FIG. 3A), the leading end of the printing plate 12 is fixedly retained by the leading end chuck 26 (step 312), and the rotating drum 16 is rotated to commence a winding-on operation (step 314).

In a next step 316, it is judged whether or not the photo-interrupter 250 has detected the trailing end of the printing plate 12. When this judgement is positive (see FIG. 3B), the routine advances to step 318, and a trailing end detection signal is outputted from the photo-interrupter 250 to the trailing end count value-reading section 254. In step 320, the trailing end detection signal acts as a trigger, and the trailing end count value L_{R} is read out by the trailing end count value-reading section 254. Then the routine advances to step 322.

In step 322, a rotation angle D (radians) of the rotating drum 16 is calculated from the leading end count value L_{F} and the trailing end count value L_{R}. Next, the routine advances to step 324, the conveyance length L₁ from the position at which the leading end chuck 26 was positioned to the photo-interrupter 250, which has been stored in advance at the L₁-value memory 252, is read out, and the radius R of the rotating drum 16, which has been stored in advance at the R-value memory 264, is read out. Then the routine advances to step 326.

In step 326, the plate length of the actual printing plate 12 (actual plate length) L is calculated from the rotation angle D, the conveyance length L₁ and the radius R of the rotating drum 16.

In a next step 328, the inputted plate length L′ stored at the inputted plate size storage section 268 is read out. In a next step 330, the difference ΔL between the actual plate length L and the inputted plate length L′ is compared with an allowable difference L_{S}, which is specified in advance.

If it is judged that ΔL<L_{S} as a result of this comparison, it is judged that the inputted size of the printing plate 12 matches the actual size. In this case, no special processing particularly needs to be executed, and usual processing continues (see FIG. 3C).

However, if it is judged that ΔL ≧L_{S}, the routine advances to step 332, an instruction that the printing plate 12 that has been partially wound onto the rotating drum 16 should be wound back is sent to the driving system control section 205, the routine advances to a next step 334, and a message (error report) to the effect of “trailing end chuck position specified by inputted size is erroneous” is displayed at the operation/display section 266.

According to the first embodiment as described above, when the printing plate 12 is wound on the rotating drum 16 and the trailing end of the printing plate 12 is detected by the photo-interrupter 250, a rotation angle D of the rotating drum 16 due to the operation of winding up till then is detected, and the actual plate length L is calculated on the basis of this rotation angle, the radius R of the rotating drum 16, and the conveyance distance L₁ from the positioned leading end chuck 26 to the photo-interrupter 250. In a case in which the difference ΔL between the actual plate length L and the inputted plate length L′ exceeds the pre-specified tolerance value L_{S}, the printing plate 12 is fed backward and separated from the rotating drum 16. As a result, damage to the rotating drum 16 and devices peripheral thereto, detachment of or damage to the printing plate 12 itself, and the like due to size mis-identification can be reliably prevented.

Second Embodiment

Below, a second embodiment of the present invention will be described. Note that structural portions that are the same as in the first embodiment are given the same reference numerals, and explanations of such structures are omitted.

A feature of the second embodiment is that the length of the printing plate 12 is calculated from a measurement of time duration.

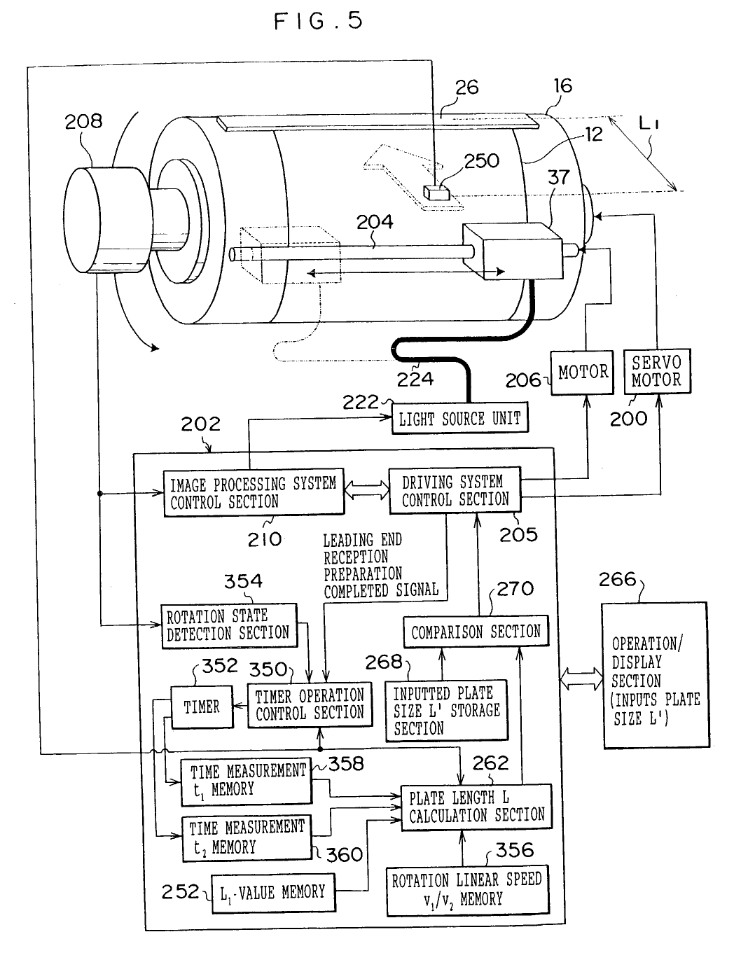

FIG. 5 shows a control system of the second embodiment for rotation of the rotating drum 16, movement of the recording head section 37, and image recording by the recording head section 37 on the basis of image signals.

In the second embodiment, for the judgement as to whether or not the size of the printing plate 12 that is fed in to the rotating drum 16 from the plate supply guide 20 matches the size identified in the apparatus (the controller 202), the photo-interrupter 250 is provided in the vicinity of the end portion of the plate supply guide 20, at the rotating drum 16 side thereof, to serve as the trailing end detection sensor.

The photo-interrupter 250 is provided with the function for detecting the trailing end of the printing plate 12 that is being guided at the plate supply guide 20 and conveyed in the tangential direction of the rotating drum 16. The position of the photo-interrupter 250 has a fixed separation from the leading end chuck 26 when the rotating drum 16 is positioned in preparation for receiving the printing plate 12. The conveyance length L₁ of the printing plate 12 between the photo-interrupter 250 position and the leading end chuck 26 is stored in advance at the L₁-value memory 252 of the controller 202.

The trailing end detection signal of the photo-interrupter 250 is connected to a timer operation control section 350 which is provided at the controller 202, and serves as a trigger for starting a timer 352. That is, a rotation state detection section 354 which, in response to signals from the rotary encoder 208, detects when the rotating drum 16 is rotating is provided at the controller 202. When the trailing end detection signal acting as the trigger is inputted to the timer operation control section 350 and the rotation of the rotating drum 16 commences, a signal to commence time measurement by the timer 352 is outputted from the timer operation control section 350.

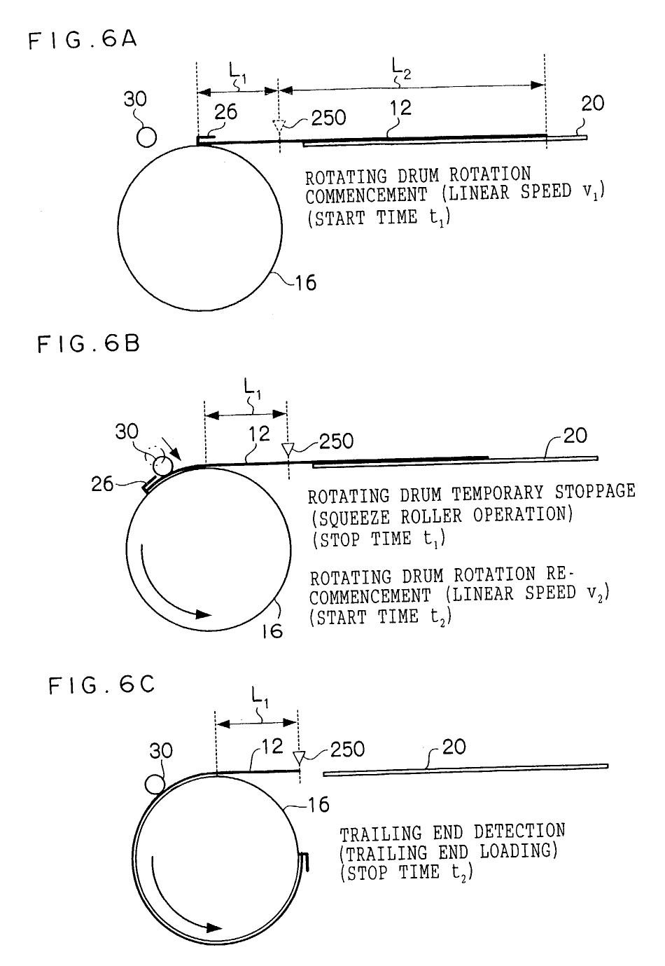

Herein, the rotation of the rotating drum 16 commences in a state in which the printing plate 12 is retained by the leading end chuck 26, as shown in FIG. 6A. A rotation linear velocity v, from this initial commencement of rotation until the rotation is temporarily halted for the squeeze roller 30 to be brought closer to the rotating drum 16 (see FIG. 6B) is specified in advance. A rotation linear velocity v₂ when the rotating drum 16 re-starts after the squeeze roller 30 has moved to push the printing plate 12 against the peripheral surface of the rotating drum 16 is also specified in advance. These rotation linear velocities v₁ and v₂ are stored at a rotation linear velocity v₁/v₂ memory 356.

When the rotation is temporarily stopped, the timer operation control section 350 temporarily stops the timer 352, reads out a measurement of duration up till then t,, and stores the time measurement t₁ at a time measurement t₁ memory 358. Further, the re-commencement of rotation of the rotating drum 16 is used as a trigger for resetting and starting the timer 352 again. At the point in time when the trailing end portion of the printing plate 12 is detected by the photo-interrupter 250 (see FIG. 6C), the timer 352 is stopped. Hence, a measurement of duration for this period t₂ is read out, and stored at a time measurement t₂ memory 360.

The rotation linear velocity v₁/v₂ memory 356, the time measurement ti memory 358, the time measurement t₂ memory 360 and the L₁-value memory 252 are respectively connected to the plate length calculation section 262. At the plate length calculation section 262, a feeding length L_{H} of an initial operation (the operation from retention by the leading end chuck 26 to the temporary stoppage) is calculated from the duration of the initial operation of the rotating drum 16 (the measured duration t₁) and the rotation linear speed v₁ of the rotating drum 16 at that time. The plate length calculation section 262 also calculates a feeding length L_{T} of a regular operation (the operation from recommencement of rotation of the rotating drum 16 after the squeeze roller 30 has pressed against the printing plate 12 until the trailing end detection) is calculated from the duration of the regular operation (the measured duration t₂) and the rotation linear speed v₂ of the rotating drum 16 at that time (see equations (9) and (10)).

L_{H}=t₁×v₁ (9)

L_{T}=t₂×v₂ (10)

Thereafter, the plate length calculation section 262 reads out L₁, and adds up the value of L₁, the feeding length of the initial operation L_{H} and the feeding length L_{T} of the regular operation. Thus, a total length L of the printing plate 12 is found (see equation 11).

L=L_{H}+L_{T}+L₁ (11)

The controller 202 is connected to the operation/display section 266, which serves as a user interface. The size L′ of the printing plate 12 to be processed can be inputted from the operation/display section 266. The size L′ inputted at the operation/display section 266 is stored at the inputted plate size storage section 268.

The inputted plate size storage section 268 and the plate length calculation section 262 are each connected to the comparison section 270. The plate length L of the actual plate size and the plate length L′ of the inputted plate size are inputted to the comparison section 270.

At the comparison section 270, the plate length L of the actual plate size and the plate length L′ of the inputted plate size are compared, and it is judged whether or not (an absolute value of) a difference therebetween ΔL is within the predetermined value L_{S} (see equation (12) following).

(|L−L′|=ΔL_{S}) (12)

Herein, “:” signifies comparison of values to the left and right thereof, and distinguishes whether ΔL<L_{S} or ΔL≧L_{S}.

The result of comparison by the comparison section 270 is outputted to the driving system control section 205 and the operation/display section 266.

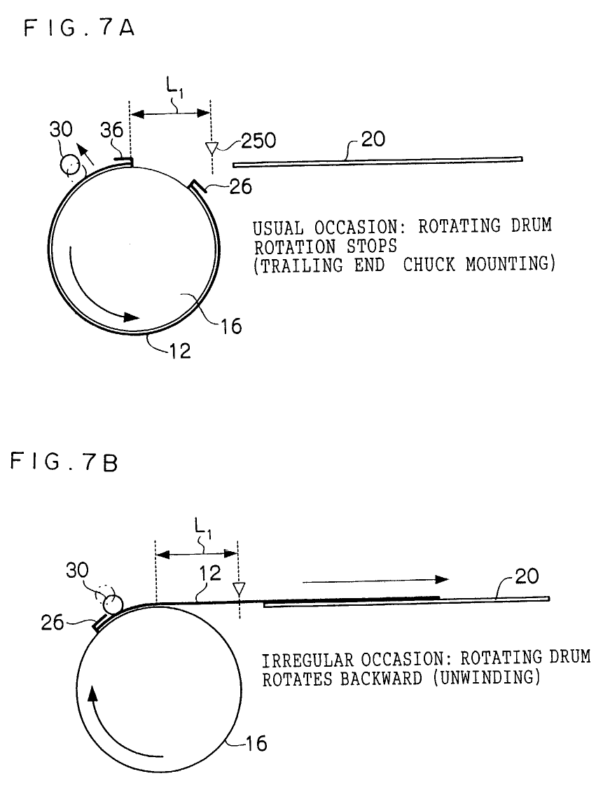

In this second embodiment, when ΔL<L_{S}, it is judged that the inputted size of the printing plate 12 matches the actual size. In this case, usual processing can continue and no special processing particularly needs to be executed (see FIG. 7A).

However, if ΔL≧L_{S}, an instruction that the printing plate 12 that is in the process of being wound onto the rotating drum 16 should be wound backward is sent to the driving system control section 205, and a message to the effect of “trailing end chuck position specified by inputted size is erroneous” is displayed at the motor 206. In such a case, the printing plate 12 may be wound back as shown in FIG. 7B.

Hence, the operation of winding the printing plate 12 onto the rotating drum 16 can be interrupted in cases in which the trailing end chuck 36 might not fixedly retain the trailing end of the printing plate 12 reliably and the like.

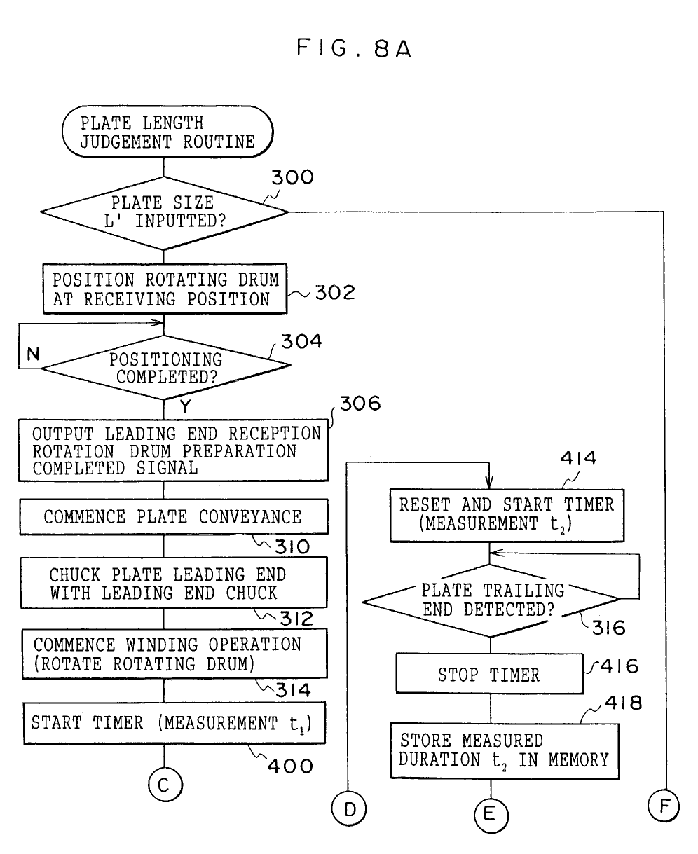

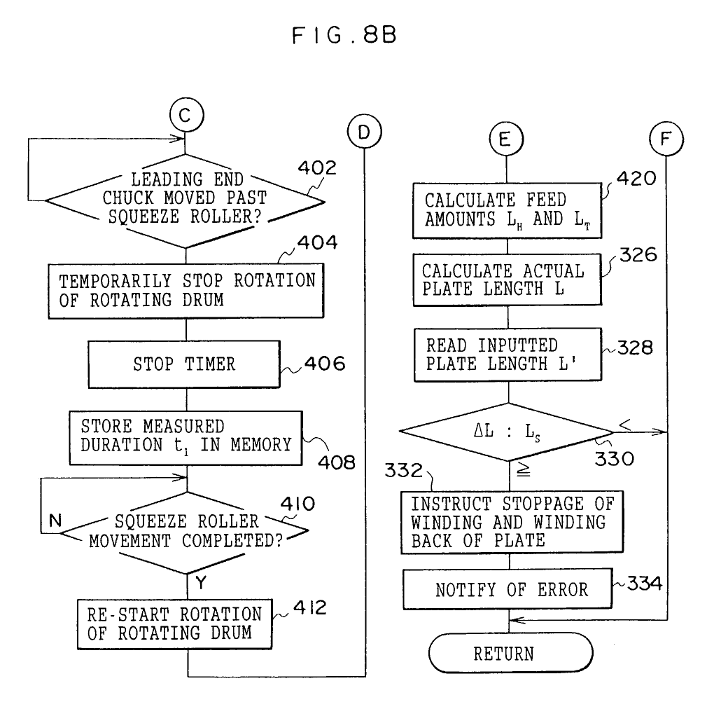

Below, operation of the second embodiment will be described in accordance with a flowchart shown in FIGS. 8A and 8B.

In step 300, it is judged whether or not the plate size L′ has been inputted by the operation/display section 266. If this judgement is positive, the routine advances to step 302 and the rotating drum 16 is positioned at the position for receiving the printing plate 12.

In the next step 304, it is judged whether or not this positioning has been completed. When this judgement is positive, the routine advances to step 306, and the leading end receiving preparation completion signal of the rotating drum 16 is outputted from the driving system control section 205 to the timer operation control section 350.

In the next step 310, conveyance of the printing plate 12 is commenced. When the leading end of the printing plate 12 arrives at the position at which the leading end chuck 26 is positioned (see FIG. 6A), the leading end of the printing plate 12 is fixedly retained by the leading end chuck 26 (step 312), and the rotating drum 16 is rotated to commence the winding-on operation (step 314).

In a next step 400, the timer 352 is started, and measurement of the measured duration t₁ is commenced.

The rotating drum 16 starts to rotate, the leading end chuck 26 is moved past the squeeze roller 30 (see FIG. 6B), and the rotating drum 16 temporarily stops (steps 402 and 404).

When the rotating drum 16 is temporarily stopped, the timer 352 is stopped in step 406, and in a next step 408, the measured duration t₁ is acquired and stored at the time measurement t₁ memory 358.

When the movement of the squeeze roller 30 (the movement to a position for pressing the printing plate 12 against the peripheral surface of the rotating drum 16) is completed, the rotating drum 16 recommences rotation (steps 410 and 412). This rotation recommencement acts as a trigger, and the timer 352 is reset and started, and commences measurement of the measured duration t₂ in step 414.

In the next step 316, it is judged whether or not the photo-interrupter 250 has detected the trailing end of the printing plate 12. When this judgement is positive (see FIG. 6C), the routine advances to step 416, and the trailing end detection signal is outputted from the photo-interrupter 250 to the timer operation control section 350 and the plate length L calculation section 262.

In step 416, the trailing end detection signal acts as a trigger, the timer 352 is stopped, and the measured duration t₂ at this time is stored at the time measurement t₂ memory 360 (step 418).

In step 420, the feed lengths L_{H} and L_{T} are calculated from the measured durations t₁ and t₂, the pre-stored rotation linear velocity v₁ during the initial operation of the rotating drum 16 and the rotation linear velocity v₂ during the regular operation of the rotating drum 16.

In step 326, the values of the feed lengths L_{H}, L_{T} and L₁ are added together, and the plate length of the actual printing plate 12 (actual plate length) L is calculated.

In the next step 328, the inputted plate length L′ stored at the inputted plate size storage section 268 is read out. In the next step 330, the difference ΔL between the actual plate length L and the inputted plate length L′ is compared with the tolerable difference L_{S}, which is specified in advance.

If it is judged that ΔL <L_{S} as a result of this comparison, it is judged that the inputted size of the printing plate 12 matches the actual size. In such a case, no special processing particularly needs to be executed, and usual processing continues (see FIG. 7A).

However, if it is judged that ΔL≧L_{S}, the routine advances to step 332, an instruction that the printing plate 12 that has been partially wound onto the rotating drum 16 should be wound back is sent to the driving system control section 205, the routine advances to the next step 334, and a message (error report) to the effect of “trailing end chuck position specified by inputted size is erroneous” is displayed at the operation/display section 266.

What is claimed is:

1. An image-recording device which, in a state in which a sheet-form recording material is wound on a peripheral surface of a rotating drum, rotates the rotating drum at a predetermined rotation speed and moves a recording head, which is disposed to face the peripheral surface of the rotating drum, in an axial direction of the rotating drum for recording an image, the image-recording device comprising:
a rotation position detection sensor which detects a rotation angle of the rotating drum;
a determined position angle storage section which stores a rotation angle of a time when a leading end chuck, which is provided at the rotating drum and fixedly retains a leading end portion of the sheet-form recording material, is positioned at a determined position for receiving the sheet-form recording material;
a trailing end detection sensor which is provided on a conveyance path of the sheet-form recording material to the rotating drum and detects a trailing end portion of the sheet-form recording material, a path length between the trailing end detection sensor and the leading end chuck when the rotating drum is positioned at the determined position being known in advance;
a trailing end detection angle acquisition section which acquires a rotation angle of the rotating drum from the rotation position detection sensor when the trailing end of the sheet-form recording material is detected by the trailing end detection sensor during an operation of winding the sheet-form recording material onto the rotating drum; and
a length dimension calculation section which calculates a length dimension of the sheet-form recording material on the basis of the rotation angle acquired by the trailing end detection angle acquisition section, a diametric dimension of the rotating drum and the path length.

2. An image-recording device which, in a state in which a sheet-form recording material is wound on a peripheral surface of a rotating drum, rotates the rotating drum at a predetermined rotation speed and moves a recording head, which is disposed to face the peripheral surface of the rotating drum, in an axial direction of the rotating drum for recording an image, the image-recording device comprising:
a leading end chuck provided at the rotating drum which fixedly retains a leading end portion of the sheet-form recording material;
a trailing end detection sensor which is provided on a conveyance path of the sheet-form recording material to the rotating drum and detects a trailing end portion of the sheet-form recording material, a path length between the trailing end detection sensor and the leading end chuck when the leading end chuck is positioned at a determined position being known in advance;
a timer which starts contemporaneously with commencement of an operation of winding the sheet-form recording material onto the rotating drum and stops when the trailing end of the sheet-form recording material is detected by the trailing end detection sensor; and
a length dimension calculation section which calculates a length dimension of the sheet-form recording material on the basis of a duration measured by the timer, rotation linear velocity of the rotating drum and the path length.

3. The image-recording device of claim 2, further comprising a squeeze roller which, during a temporary stoppage of the rotating drum after rotation has commenced in a state in which the leading end of the sheet-form recording material is retained by the leading end chuck and the leading end chuck has passed the squeeze roller, moves in a direction approaching the rotating drum from a position that is separated from the rotating drum, the squeeze roller continuing so as to push the sheet-form recording material against the peripheral surface of the rotating drum during re-commenced rotation operation of the rotating drum, wherein the timer measures durations of rotation of the rotating drum before and after the temporary stoppage respectively separately.

4. The image-recording device of claim 1, further comprising:
an input section for inputting a length dimension of the sheet-form recording material;
a comparison section which compares the dimension inputted at the input section with the dimension calculated at the length dimension calculation section; and
a notification section which gives notice of a result of the comparison by the comparison section.

5. The image-recording device of claim 2, further comprising:
an input section for inputting a length dimension of the sheet-form recording material;
a comparison section which compares the dimension inputted at the input section with the dimension calculated at the length dimension calculation section; and
a notification section which gives notice of a result of the comparison by the comparison section.

6. The image-recording device of claim 3, further comprising:
an input section for inputting a length dimension of the sheet-form recording material;
a comparison section which compares the dimension inputted at the input section with the dimension calculated at the length dimension calculation section; and
a notification section which gives notice of a result of the comparison by the comparison section.

7. The image-recording device of claim 1, further comprising:
an input section for inputting a length dimension of the sheet-form recording material;
a comparison section which compares the dimension inputted at the input section with the dimension calculated at the length dimension calculation section; and
a processing interruption section which interrupts winding processing of the sheet-form recording material in a case in which a result of the comparison at the comparison section does not coincide with a pre-specified allowable range.

8. The image-recording device of claim 2, further comprising:
an input section for inputting a length dimension of the sheet-form recording material;
a comparison section which compares the dimension inputted at the input section with the dimension calculated at the length dimension calculation section; and
a processing interruption section which interrupts winding processing of the sheet-form recording material in a case in which a result of the comparison at the comparison section does not coincide with a pre-specified allowable range.

9. The image-recording device of claim 3, further comprising:
an input section for inputting a length dimension of the sheet-form recording material;
a comparison section which compares the dimension inputted at the input section with the dimension calculated at the length dimension calculation section; and
a processing interruption section which interrupts winding processing of the sheet-form recording material in a case in which a result of the comparison at the comparison section does not coincide with a pre-specified allowable range.

10. A recording material winding state monitoring method which is employed at an image-recording device which, in a state in which a sheet-form recording material is wound on a peripheral surface of a rotating drum, rotates the rotating drum at a predetermined rotation speed and moves a recording head, which is disposed to face the peripheral surface of the rotating drum, in an axial direction of the rotating drum for recording an image, the method being for monitoring whether or not a dimension of the sheet-form recording material that is wound on accords with an inputted size, the method comprising the steps of:
preparatorily storing a conveyance length, from a position at which a leading end of the sheet-form recording material is fixedly retained at the rotating drum to a predetermined position on a conveyance path for feeding the sheet-form recording material to the rotating drum;
detecting a rotation angle of the rotating drum in rotating from commencement of winding of the sheet-form recording material onto the rotating drum, at a point in time at which the leading end of the sheet-form recording material has been fixedly retained at the rotating drum, until a trailing end of the sheet-form recording material reaches the predetermined position;
calculating an actual dimension of the sheet-form recording material from the rotation angle, a diametric dimension of the rotating drum and the conveyance length;
comparing the inputted size dimension with the calculated dimension; and
giving notice of a result of the comparison.

11. A recording material winding state monitoring method which is employed at an image-recording device which, in a state in which a sheet-form recording material is wound on a peripheral surface of a rotating drum, rotates the rotating drum at a predetermined rotation speed and moves a recording head, which is disposed to face the peripheral surface of the rotating drum, in an axial direction of the rotating drum for recording an image, the method being for monitoring whether or not a dimension of the sheet-form recording material that is wound on accords with an inputted size, the method comprising the steps of:
preparatorily storing a conveyance length, from a position at which a leading end of the sheet-form recording material is fixedly retained at the rotating drum to a predetermined position on a conveyance path for feeding the sheet-form recording material to the rotating drum;
measuring a duration of winding the sheet-form recording material onto the rotating drum, including the sub-steps of commencing a time measurement from a point in time at which the leading end of the sheet-form recording material has been fixedly retained at the rotating drum and the rotating drum has commenced rotation, and finishing the time measurement at a point in time at which a trailing end of the sheet-form recording material has reached the predetermined position;
calculating an actual dimension of the sheet-form recording material from the measured duration, a linear speed of rotation of the rotating drum and the conveyance length;
comparing the inputted size dimension with the calculated dimension; and
giving notice of a result of the comparison.

12. The recording material winding state monitoring method of claim 10, further comprising, in a case in which the result of the comparison does not coincide with an allowable range, the steps of feeding the sheet-form recording material backward and removing the sheet-form recording material from the rotating drum.

13. The recording material winding state monitoring method of claim 11, further comprising, in a case in which the result of the comparison does not coincide with an allowable range, the steps of feeding the sheet-form recording material backward and removing the sheet-form recording material from the rotating drum.
